(19) United States
(12) Patent Application Publication
(10) Pub. No.: US 2010/0058207 A1
(43) Pub. Date: Mar. 4, 2010

(54) Interactivity Platform System and Method

(76) Inventors: Benjamin Hamey, Barton (AU); Jeffrey Cotter, Gilmore (AU); Nathan Hamey, Barton (AU)

Correspondence Address: DALY, CROWLEY, MOFFORD & DURKEE, LLP, SUITE 301A, 354A TURNPIKE STREET, CANTON, MA, 02021-2714, US

(21) Appl. No.: 12/423,593

(22) Filed: Apr. 14, 2009

(30) Foreign Application Priority Data
Sep. 2, 2008 (AU) 2008207678

(51) Int. Cl. G06F 3/048

(52) U.S. Cl. 715/763

(57) ABSTRACT

A system and method permitting each of a plurality of users to create, populate and share a decentralised virtual world using an applications platform with a peer to peer network.

### CROSS REFERENCE TO RELATED APPLICATION

This application claims priority to and the benefit of Australian Patent Application No. 2008207678 filed on Sep. 2, 2008, the entire contents of which is incorporated herein by reference.

### FIELD OF THE INVENTION

In a general aspect the present invention relates to building virtual worlds using high quality graphics and rendering capabilities, and sharing the user-owned-and-created worlds via personalised social networks. More preferably, the invention provides a platform for creating and configuring 3D content that is rich in graphics and rendering capabilities, and importing the content into a decentralised user-owned-and-created world for sharing with a selection of users via personalised social networks, including, but not limited to, communications mediums such as text-based chat, VoIP and graphic visualization.

### BACKGROUND OF THE INVENTION

A virtual world is a simulated computer environment providing space for users to interact. Some virtual worlds, such as Second Life and Multiverse provide space for users to simulate 3D content within the virtual world program. In such existing virtual world programs, content quality, in terms of graphics and rendering capabilities, does not provide a highly interactive user experience. Typically, existing virtual worlds come as one centralised world that is shared by all users. Such centralised worlds allow a user to build content inside the world using only the tools provided inside the virtual world. Other existing virtual worlds, such as Multiverse, allow importation of content. The centralised nature of these existing virtual worlds places a limit on the richness in content that can be applied in simulation.

A social network is a structure of nodes that are linked together by some form of interdependency. Typically, social networks do not have a point or a goal. They exist as space for users to interact and socialise. Some social networks, such as Skype, MSN, and Yahoo, are text-based and VoIP-based instant messengers, while other social networks, such as Facebook, You Tube, and Flickr, are text and media based. However, these existing social networks serve as a means to communicate and do not provide any real world tools for compiling multiple forms of content into one unique composition inside the networks.

It has long been known that the gaming industry is the leader in providing rich 3D content. Games usually come as a 3D software entertainment package with a point or a goal to be achieved. They have high graphics and rendering capabilities, but they do not allow the user to personalise the game with user created content under a framework that supports social networking.

The reference to any prior art in this specification is not, and should not be taken as an acknowledgement or any form of suggestion that the referenced prior art forms part of the common general knowledge in Australia.

### SUMMARY

In a preferred aspect, the invention is adapted to provide a computer-based program for real users to build decentralised user-owned-and-created virtual worlds. In another preferred aspect, the invention is adapted to provide a platform for building high quality 3D content rich in graphics and rendering capabilities and importing and sharing such content into the user's virtual world. In yet another preferred aspect, the invention is adapted to provide a platform for communicating with a selection of friends via a personalised social network.

The present invention in one preferred aspect provides for a system for generating a virtual world, including a storage medium having an applications platform for creating a virtual world, the applications platform being configured to permit each of a plurality of users to create a virtual world; an input device adapted to permit the user to create objects to populate the virtual world; and a processor coupled to the storage medium and the input device. The processor is configured to operate a peer to peer network between the users of the applications platform.

In another preferred aspect, the present invention provides a method for generating a virtual world, including: providing an applications platform to a plurality of users, the applications platform being configured to communicate with each user using a peer to peer network, and permit each user to build a virtual world and populate the virtual world with content.

In a further preferred aspect, the invention provides a method for generating a virtual world, including sharing an applications platform with a plurality of users using a peer to peer network; creating a virtual world on the applications platform; and populating the virtual world with content.

In yet another preferred aspect, the present invention provides a method for generating and sharing a user-owned 3D virtual world in a computer based program, the method comprising the steps of authoring the virtual world; composing content from an arbitrary set of materials for use in the virtual world; and sharing the virtual world with a network of selected users.

### BRIEF DESCRIPTION OF THE FIGURES

FIG. 1 illustrates a schematic of a system in accordance with a preferred embodiment of the present invention.

FIG. 2 illustrates a high level process diagram of the system of FIG. 1.

FIG. 3 illustrates a process diagram of the building of a virtual world as part of the system of FIG. 2.

FIG. 4 illustrates a process diagram of the content development and sharing portion of the system of FIG. 2.

FIG. 5 illustrates a process diagram of the communications portion of the system of FIG. 2.

FIG. 6 illustrates a high level diagram of preferred features in accordance with a preferred embodiment of the present invention.

### DETAILED DESCRIPTION

Alternative embodiments of the invention will be apparent to those skilled in the art from consideration of the specification and practice of the invention disclosed herein. It is intended that the specification and examples be considered as exemplary only, with a true scope and spirit of the invention being indicated by the claims which follow. For the purposes of simplicity, a typical use of the system will be described below. However, it will become apparent to a person skilled in the art of virtual worlds and social networking that there may be ample other uses of the system. More specifically, it will become apparent that the system can be used in part or in its entirety depending on the user's objectives.

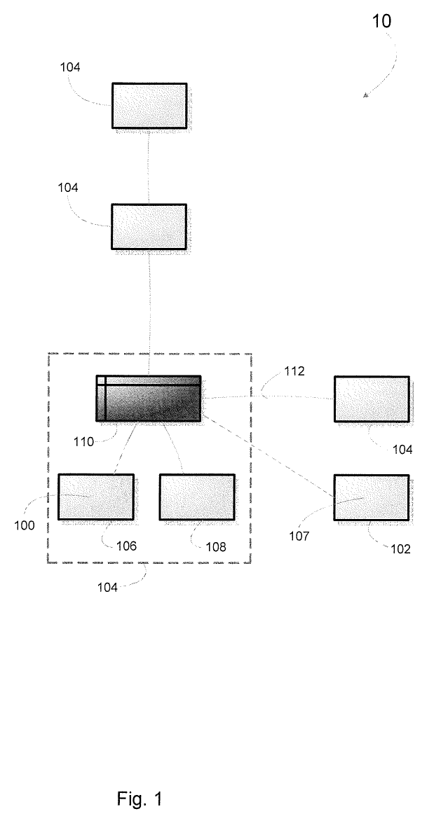

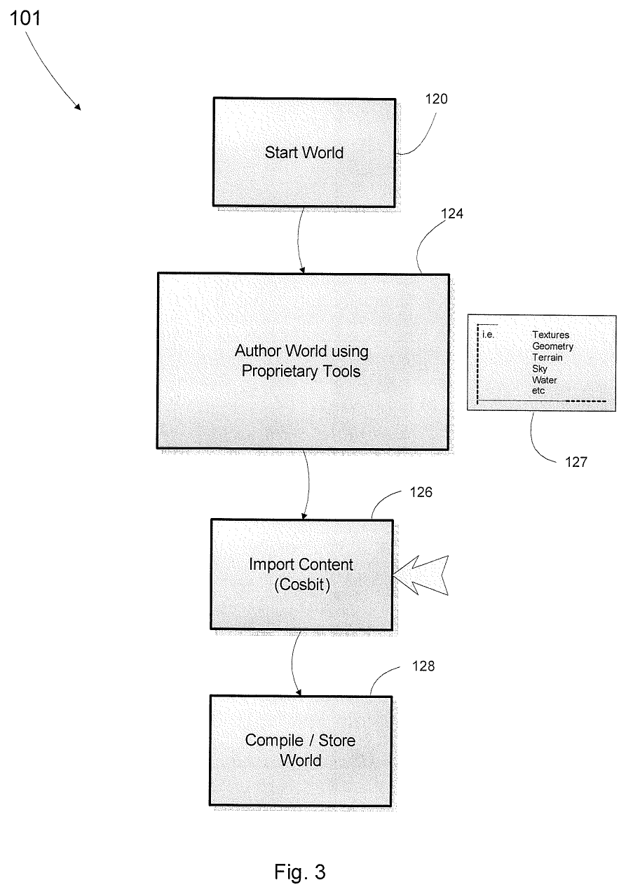

FIGS. 1 to 6 show a preferred embodiment of a system 10 and method for generating a virtual world. The preferred elements of system 10 and their interrelationship are described below.

Referring to FIG. 1, system 10 preferably includes an applications platform 100 which is preferably initially stored on a central server 102 in communication with one or more user locations 104. Central server 102 preferably includes a storage medium for storing the applications platform. Central server 102 is preferably controlled by the provider (usually the author) of platform 100. Applications platform 100 is preferably a program having a framework for providing a foundational structure and environment in which one or more users may each create, populate and share his/her own virtual world. Applications platform 100 preferably includes a world creation portion 101, a content development/sharing portion 103 and a communications portion 105. The platform may be copied, downloaded or otherwise transferred to a user location 104 for use by a user. An exemplary method of creating a virtual world using the platform is set forth in more detail below.

Each user location 104 preferably includes a local storage medium 106, an input 108 and a processor 110. Storage medium 106 is preferably configured to store applications platform 100 for creating a virtual world. Exemplary storage mediums include, but are not limited to a hard drive, a flash drive, or other portable and/or integrated memory element.

Input device 108 is adapted to permit the user to create or manipulate objects to populate the virtual world. Examples of input devices include, but are not limited to a keyboard, mouse, and/or voice or touch activated input means. Other inputs may be used as desired.

Processor 110 may take a number of forms as would be appreciated by those of skill in the art. For example only, processor 110 may be a personal computing device which may be portable and/or handheld. Examples of personal computing devices include, but are not limited to a desktop computer, laptop computer, game console or a mobile phone. It will be appreciated that storage medium 106, input device 108 and processor 110 may form an integral unit if desired.

User locations 104 are each preferably connected to one another by a peer to peer network 112. It is envisaged that other type of networks may be used in order to achieve a desired result. Interaction between the components shown in FIG. 1 is further described below.

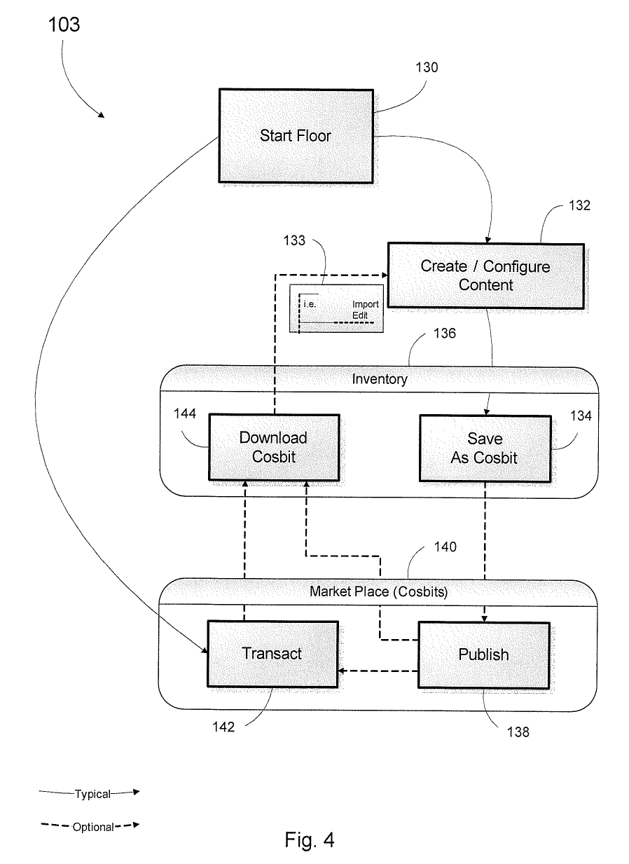

Referring to FIGS. 1 to 3, preferably the user begins in step 120 by accessing a website associated with central server 102 and registers in step 122 as user in the database. Once registered, the user preferably can access proprietary tools to create a virtual world from scratch in step 124, and/or download a template virtual world in step 126. Either way, the user can author the world and modify it in any way. Authoring the virtual world preferably involves modifying features such as texture, geometry, terrain, sky, water and similar characteristics of a virtual world, as shown in box 127. Once the framework of the virtual world is created and/or downloaded, the user preferably has an option of importing content into the virtual world from content development/sharing portion 103 of the platform describe below and shown in FIG. 4.

The virtual world is preferably the framework in which contents can later be added if desired. Once the user is satisfied with the virtual world, in step 128 the user compiles and stores the virtual world on his/her personal computer. The virtual world preferably becomes a decentralised, user-owned and user-created virtual world. The user may then share his/her virtual world with a selection of friends also registered in a central database associated with central server 102, controlled by the platform provider.

A decentralised virtual world is preferably built or created using P2P (peer-to-peer) network architecture as shown in FIG. 1. The user-owned and user-created virtual world belongs to, and is preferably stored by the user, meaning that the user is the “master” of his/her own world. One of the advantages of localised storage of the virtual world is that the user-owned and user-created virtual world can be rich in content since the provider of the platform does not have to store virtual worlds or contents within the virtual worlds for each and every user of the program. In a decentralised virtual world, preferably the user chooses who with to share the virtual world, and controls how to share his/her virtual world.

In contrast, a centralised virtual world is one where the provider of the program owns the world and shares the single or limited virtual world via the internet, for example MMOG (massively multi-user online gaming) network architecture. In a centralised virtual world, users can only contribute to a single world open to view by all users. For example, a user can visit the world to do things like purchase a piece of land and modify that piece of land or add simple contents. As a result of centralised worlds being stored by the provider of the worlds, and users having to stream content, there are severe limitations of the richness of the contents within centralised virtual worlds. Furthermore, a centralised virtual world lacks a sense of real ownership or privacy as all users can view the entire world. In addition, a centralised virtual world is often intimidating to average users in the sense that the user shares the virtual world with strangers rather than friends.

Referring to FIGS. 1, 2 and 4, once the framework of the user-owned and user-created virtual world is built, in step 130 the user may access content development/sharing portion 103 of the platform to create or configure content in step 132. The user can either import content in step 133 from an outside program such as 3D Studio Max, an external database, or simply create content inside the platform using tools provided within. Furthermore, the user may import content from an outside program and edit the imported content using the tools provided within content development/sharing portion 103 of the platform. Content can include any item of data capable of representation in a 3D world, including, but not restricted to 3D models, 2D imagery, sound, text, symbols and metadata. For example a computer, communications system and storage system on a vehicle to show vehicle location, speed, direction, altitude, fuel remaining; images from cameras on vehicle; map images and symbols from a navigation system; and voice and text messages from people in the vehicle.

Composing content from an arbitrary set of materials preferably includes superimposing or adding functional behaviour to the content. For example, the user can assign functional behaviour to an object such as a car so that if the car hits another object while travelling under 20 km/hr, the body of the car simply bends or crumbles, but the car is still drivable. If the car hits another object while travelling between 20 and 50 km/hr, the body of the car bends or crumbles and is no longer drivable. If the car hits another object while travelling over 50 km/hr, the car explodes. Another example of assigning behavioural function to content is that the user can set up a dog such that if the user's cursor hovers over the dog, the dog barks. Behaviour characteristics may be programmed to take into account any combination of relative velocity; environmental conditions such as temperature, weather (rain, wind, etc.), light, dry or wet; sound; and time. Behaviour characteristics may be assigned to inanimate objects such as cars, or “live” objects (e.g., avatars, animals, insects, plant life, microscopic organisms, etc.).

Once content has been composed in the content development/sharing portion of the platform, in step 134 the user then preferably saves the content in an inventory 136 as a “Cosbit” (a format preferably specific to the content development/sharing portion of the platform). The user can access the inventory at any time to download any content he/she may have saved.

In addition to the feature of creating or configuring content, in step 138 the user can publish his/her content in a market place 140 where the user can set permissions as to how that content can be traded in the market place. For example, the user may choose to publish a 3D model of a car and advertise the model for sale. Alternatively, the user can advertise the model as free to be downloaded by any other user. Once another user responds to the advertisement, in step 142 a transaction is conducted between the users. The transaction may involve currency or credits, for use in the virtual world and/or in the real world.

The market place is not necessarily linked to the creation of content. For example, a non-creative user may simply access the market place and purchase content without attempting to create his/her own content. In this case, in step 144 the user would download the content preferably as a Cosbit into his/her inventory 136 and use the downloaded content in any preferred manner according to the permissions assigned to a selected Cosbit.

A typical use of the content in the user's inventory would be to insert the content into the user-owned and user-created virtual world to enhance the contents within the user's virtual world.

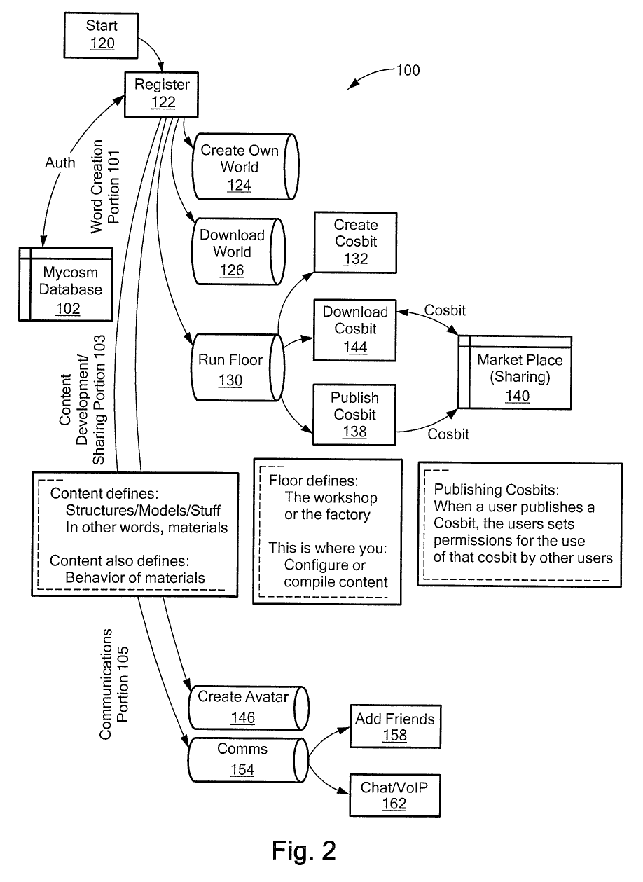

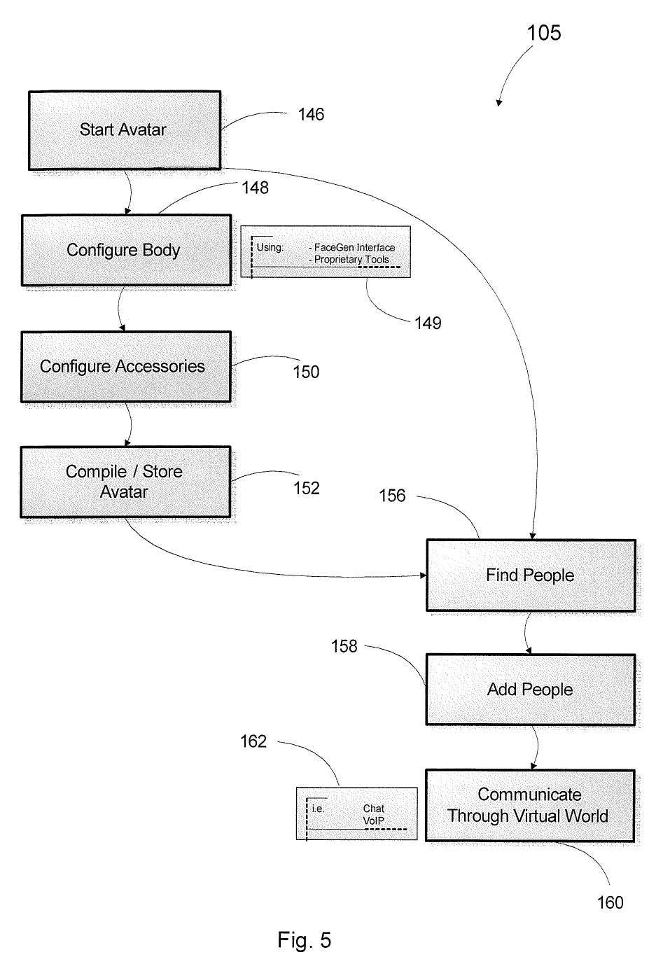

Referring to FIGS. 2 and 5, the user may access communications portion 105 of the platform of the program and in step 146 create an avatar in the form of a 3D presence or electronic representation. Communications portion 105 of platform 100 preferably enables the user to create a 3D moving model as opposed to a picture. As an option, communications portion 105 of the platform provides the user with tools to personalise the avatar by configuring the body in step 148, which is preferably accomplished by using proprietary tools 149; or furthermore configure accessories around the avatar in step 150. Once the user is satisfied with the modified avatar, in step 152 the avatar is compiled and stored preferably on the user's computer. An avatar may be downloaded without modification if desired. In step 154, the user can then communicate with other users, find other users in step 156 and add them in step 158 to his/her contact list. The first user may then assign other users with specific access rights to his/her virtual world. In step 160, the user can use platform 100 to chat with other selected users via text chat or VoIP 162 while within the virtual world. The user can then utilise the modified avatar to communicate with other users.

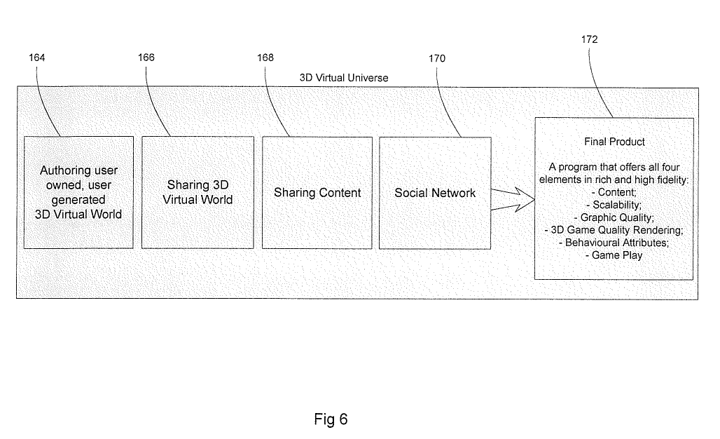

FIG. 6 shows preferred functions of the present invention and how the preferred functions result in an improved final product. Among the many benefits provided by the present invention in a preferred aspect, the user may create and own his/her virtual world (box 164). The user may share the virtual world with one or more other users (box 166). The user may create and selectively share content for use in the virtual world with one or more other users (box 168). The user may build a social network with one or more other users (box 170). Preferably one or more of these features results in a final product that is rich in content and provides scalability, superior graphic quality, 3D game quality rendering, life-like behaviour attributes and enhanced game play (box 172).

It will be appreciated that the steps described above may be performed in a different order, varied, or some steps omitted entirely without departing from the scope of the present invention.

The foregoing description is by way of example only, and may be varied considerably without departing from the scope of the present invention. For example only, the applications platform may include more than or less than three portions or modules. An additional portion may be created to permit for the passage of time so that when the user is not actively in the virtual world (e.g., logged off), the virtual world may continue to evolve or age. A user may create multiple worlds if desired. For example, the user may create, populate and share a solar system, galaxy or universe. Platform portions may be stored at a single location or at different locations.

The applications platform may be used offline (i.e., without the internet). For example, the virtual world may be created and/or populated entirely offline by the user. Other users invited by a first user may be designated as friends and granted permission to visit the virtual world of the first user. Registration of other users may be controlled by the first user and/or by the platform provider.

The features described with respect to one embodiment may be applied to other embodiments, or combined with or interchanged with the features of other embodiments, as appropriate, without departing from the scope of the present invention.

It will of course be realised that the above has been given only by way of illustrative example of the invention and that all such modifications and variations thereto as would be apparent to persons skilled in the art are deemed to fall within the broad scope and ambit of the invention as herein set forth.

The claims defining the invention are as follows:

1. A system for generating a virtual world, including:
a storage medium having an applications platform for creating a virtual world, the applications platform being configured to permit each of a plurality of users to create a virtual world;
an input device adapted to permit the user to create objects to populate the virtual world; and
a processor coupled to said storage medium and said input device, said processor being configured to operate a peer to peer network between the users of the applications platform.

2. The system of claim 1, wherein the applications platform is configured to accept user-created objects with behaviour characteristics.

3. The system of claim 1, wherein the applications platform is configured to permit user-created objects to be transferred from one user to another user.

4. The system of claim 3, wherein the applications platform is configured to transfer a user-created object from a first user to a second user on command from the first user.

5. The system of claim 1, wherein the applications platform is configured to create the virtual world off-line.

6. A method for generating a virtual world, including:
providing an applications platform to a plurality of users, the applications platform being configured to communicate with each user using a peer to peer network, and permit each user to build a virtual world and populate the virtual world with content.

7. The method of claim 6, wherein the content is customisable by the user.

8. A method for generating a virtual world, including:
sharing an applications platform with a plurality of users using a peer to peer network;
creating a virtual world on the applications platform; and
populating the virtual world with content.

9. The method of claim 8, further including customising the content according to the preferences of the user.

10. The method of claim 8, further including assigning behaviour characteristics to at least a portion of the content.

11. The method of claim 10, wherein the step of assigning includes adapting the content to react to conditions of an environment in the virtual world in which the content is placed.

12. The method of claim 11, wherein one of the conditions includes velocity relative to the content.

13. The method of claim 12, wherein the velocity is variable.

14. The method of claim 10, wherein the content is a cosbit.

15. The method of claim 8, further including controlling access to the applications platform by each of the users.

16. The method of claim 8, further including transferring a content from one user to another user.

17. The method of claim 16, wherein the transfer involves a payment to an originating user.

18. The method of claim 8, further including saving the virtual world onto a personal computing device.

19. The method of claim 18, wherein the personal computing device is a laptop computer or hand held device.

20. The method of claim 8, wherein the step of creating is conducted offline.

21. The method of claim 8, wherein the content includes an avatar configured as a 3D moving model.

22. A method for generating and sharing a user-owned 3D virtual world in a computer based program, the method comprising the steps of:
authoring said virtual world;
composing content from an arbitrary set of materials for use in said virtual world;
sharing said virtual world with a network of selected users; and
assigning behaviour characteristics to at least a portion of the content.

23. The method of claim 22, wherein said network of selected users utilises a peer to peer network architecture, which includes a communications network, peer to peer protocol, and peer to peer network protocol.

24. The method of claim 22, wherein said composed content is composed in a format specific to said computer based program.

25. The method of claim 22, wherein said content is stored in a user inventory.

26. The method of claim 22, wherein said content is published in a market place for transaction with other users of said computer based program.

27. The method of claim 22, wherein said content is simulated inside the computer based program, using tools provided within the computer based program.

28. The method of claim 22, wherein said content is imported from outside the computer based program, while honouring all attributes of said content that have been ascribed to said content in other graphic or rendering programs.

29. The method of claim 22, wherein the computer based program is accessible to each one of a plurality of users.

30. The method of claim 22, wherein the content includes an avatar configured as a 3D moving model.
